(19) United States
(12) Patent Application Publication
(10) Pub. No.: US 2006/0187792 A1
(43) Pub. Date: Aug. 24, 2006

(54) Multilayer optical disc having a layer indication

(75) Inventors: Pierre Hermanus Woerlee, Eindhoven (NL); Wilhelmus Robert Koppers, Eindhoven (NL); Hubert Cecile Francois Martens, Eindhoven (NL); Ronald Joseph Antonius Van Den Oetelaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/549,642

(22) PCT Filed: Mar. 10, 2004
(86) PCT No.: PCT/IB04/50221

§ 371 Date: Sep. 20, 2005

(30) Foreign Application Priority Data
Mar. 24, 2003 (EP) 03100755.2

(51) Int. Cl. G11B 7/00

(52) U.S. Cl. 369/59.25

(57) ABSTRACT

A multilayer record carrier is for recording information by writing marks representing addressable blocks in a track. Each recording layer has a pre-formed recording control pattern for indicating the track, the pattern comprising physical addresses (59) that indicate the physical position of the physical address with respect to a starting point of the track. The predefined number of bits of the physical address indicates the physical position with respect to a starting point of the track. At least one address bit of the predefined number of address bits of the physical address is allocated as a layer address bit (60) that has a value indicating the recording layer. A recording device has a layer unit (34) for detecting a recording layer in dependence of the layer address bit.

The invention relates to a record carrier of a writable type for recording information by writing marks in a track.

The invention further relates to a device for recording the record carrier.

An optical recording medium is known from U.S. Patent Application U.S. 2002/0031063. The record carrier has a plurality of recording layers that each comprise a guide groove, usually called pregroove, for indicating the position of tracks in which the information is to be represented by recording optically readable marks. The pregroove is meandering by a periodic excursion of the track in a transverse direction (further denoted as wobble). A scanning device is provided with a head for generating a beam of radiation for scanning the track. The marks are detected during said scanning by variations of the reflectivity of the scanned surface. The variations in intensity of the reflected radiation are detected by a main detector system. Furthermore the scanning device generates tracking servo signals based on the pregroove to position the head on the track. The wobble has a different period on different recording layers for detecting a target layer for recording by monitoring the wobble period. In particular a recording device is arranged for detecting recording errors if recording takes place on a layer differing from the target layer on which recording was intended. A problem of the recording system is that a wobble frequency detection unit must be included in the recording device, and that an erroneous decision on the wobble frequency may occur due to a degraded wobble detection signal, e.g. due to dirt or scratches.

Therefore it is an object of the invention to provide a record carrier and a scanning device for detecting a recording layer in a more convenient way.

According to a first aspect of the invention the object is achieved with a record carrier of a writable type for recording information by writing marks in a track via a beam of radiation entering through an entrance face of the record carrier, the marks being recorded in recording units representing addressable blocks of information, the record carrier comprising at least a first recording layer and a second recording layer, the first recording layer being present at a position closer to the entrance face than the second recording layer, each recording layer comprising a pre-formed recording control pattern for indicating the track, the pattern comprising physical addresses having a predefined number of address bits that indicate the physical position of the physical address with respect to a starting point of the track, and at least one address bit of said predefined number of address bits of the physical address constituting at least one layer address bit that has a value indicating the recording layer.

According to a second aspect of the invention the object is achieved with a device for recording marks in a track on the above record carrier via a beam of radiation, the device comprising a head for providing the beam, recording means for writing marks in the track via the beam, the marks being recorded in recording units representing addressable blocks of information, a front-end unit for generating a scanning signal for detecting marks in the track, and demodulation means for retrieving the physical addresses including the at least one layer address bit from the pre-formed recording control pattern, and a layer unit for detecting a recording layer in dependence of the at least one layer address bit.

The effect of the measures is that the layer information is available directly with the physical address information. The advantage is that no separate layer information needs to be retrieved.

The invention is also based on the following recognition. A pre-existing recordable format for single layer discs may already be in the market like for DVD+RW. Compatibility to such a pre-existing recording format is required. Including additional layer information as separate or additional bits has the disadvantage that the layer information cannot easily be retrieved. The inventors have seen that some of the bits that are already assigned to indicate a physical address can be redefined to indicate the layer information without reducing compatibility.

In an embodiment of the record carrier a pregroove on the first recording layer extends spirally in a first direction and a pregroove on the second recording layer extends spirally in a second direction opposite to the first direction for constituting a multi-part recording area interrupted by an intermediate zone that physically is constituted by a first intermediate part located at the end of the first recording layer and a second intermediate part located at the start of the second recording layer, and the layer address bit has the value one in the second recording layer. This has the advantage that the layer address bit has a corresponding value to the address bits of a dual layer opposite track path DVD.

In an embodiment of the device the recording means are arranged for recording the units representing addressable blocks of information including a logical address field, the logical address field containing a logical address value based on the physical address but differing from the physical address by excluding the at least one layer address bit. This has the advantage that a second recording layer can be recorded according to a predefined logical addressing scheme, while the physical addresses are available for indicating the layer. This is particularly relevant for recording a dual layer record carrier according to the DVD parallel track path (PTP) format.

Further preferred embodiments of the device according to the invention are given in the further claims.

These and other aspects of the invention will be apparent from and elucidated further with reference to the embodiments described by way of example in the following description and with reference to the accompanying drawings, in which

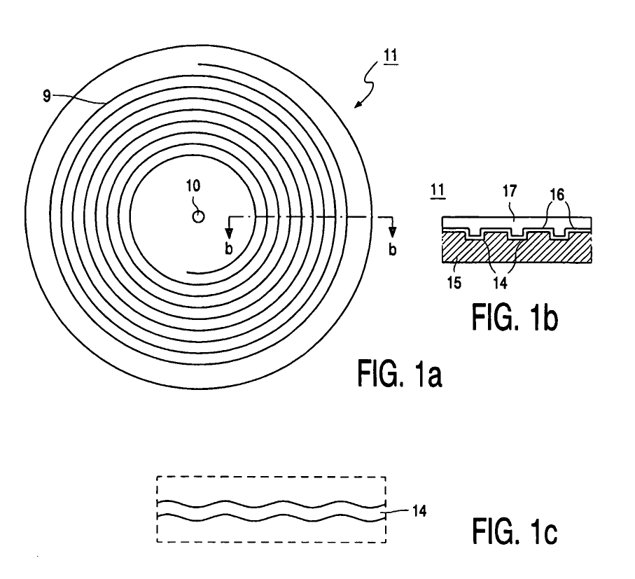

FIG. 1a shows a disc-shaped record carrier (top view),

FIG. 1b shows a cross-section taken of the record carrier,

FIG. 1c shows an example of a wobble of the track,

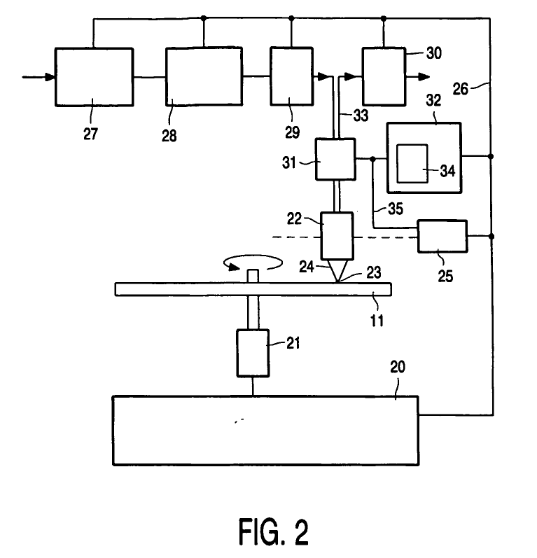

FIG. 2 shows a recording device for retrieving layer information from physical address information,

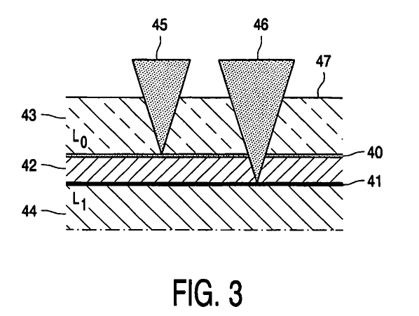

FIG. 3 shows a multilayer optical disc,

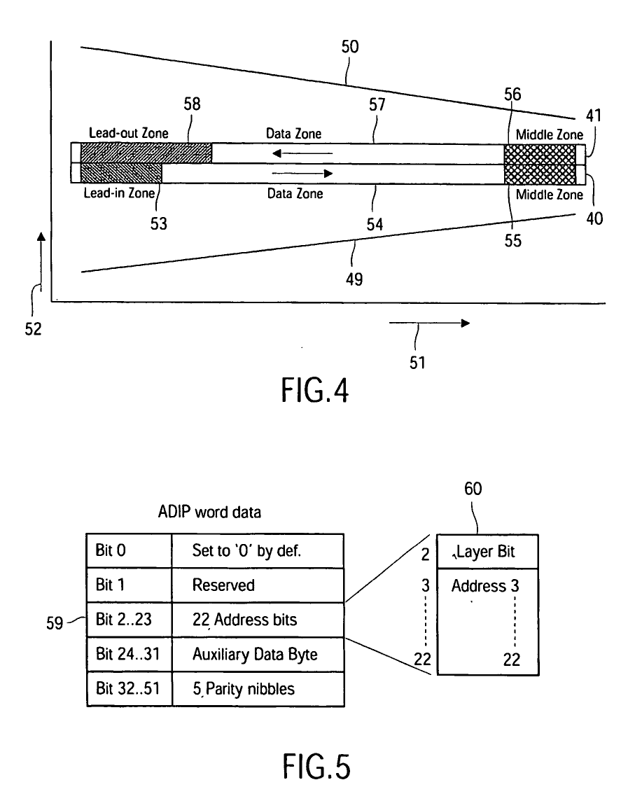

FIG. 4 shows schematically an opposite track path record carrier,

FIG. 5 shows physical address information and layer information,

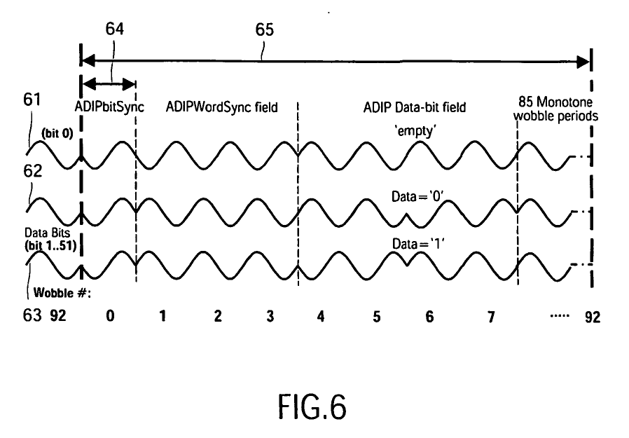

FIG. 6 shows ADIP information in wobble modulation, and

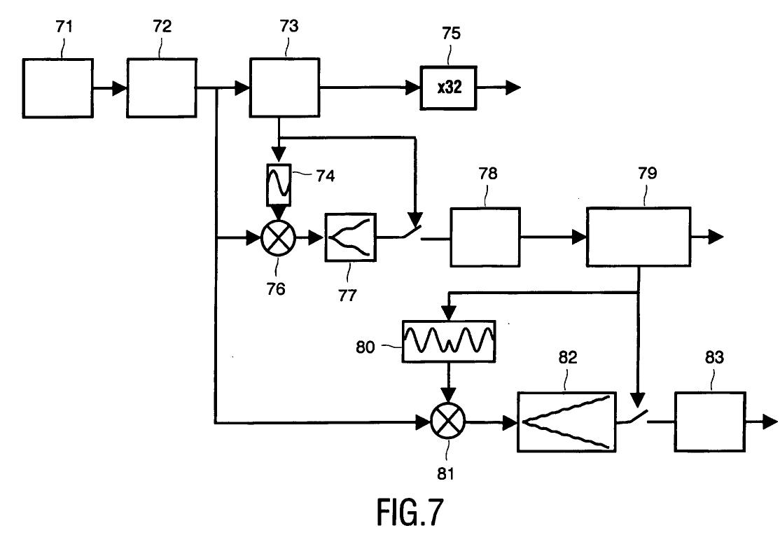

FIG. 7 shows a wobble demodulation unit.

In the Figures, elements which correspond to elements already described have the same reference numerals.

FIG. 1 a shows a disc-shaped record carrier 11 having a track 9 and a central hole 10. The track 9 is arranged in accordance with a spiral pattern of turns constituting substantially parallel tracks on an information layer. The record carrier may be an optical disc having an information layer of a recordable type. Examples of a recordable disc are the CD-R and CD-RW, and the DVD+RW. The track 9 on the recordable type of record carrier is indicated by a pre-embossed track structure provided during manufacture of the blank record carrier, for example a pregroove. Recorded information is represented on the information layer by optically detectable marks recorded along the track. The marks are constituted by variations of a physical parameter and thereby have different optical properties than their surroundings. The marks are detectable by variations in the reflected beam, e.g. variations in reflection.

FIG. 1b is a cross-section taken along the line b-b of the record carrier 11 of the recordable type, in which a transparent substrate 15 is provided with a recording layer 16 and a protective layer 17. The track structure is constituted, for example, by a pregroove 14 which enables a read/write head to follow the track 9 during scanning. The pregroove 14 may be implemented as an indentation or an elevation, or may consist of a material having a different optical property than the material of the pregroove. The pregroove enables a read/write head to follow the track 9 during scanning. A track structure may also be formed by regularly spread sub-tracks which periodically cause servo signals to occur. User data is to be recorded in recording units representing addressable blocks of information, for example formatted as sectors in the DVD recording format. The record carrier may be intended to carry real-time information, for example video or audio information, or other information, such as computer data.

FIG. 1c shows an example of a wobble of the track. The Figure shows a periodic variation of the lateral position of the track, also called wobble. The variations cause an additional signal to arise in auxiliary detectors, e.g. in the push-pull channel generated by partial detectors in the central spot in a head of a scanning device. The wobble is, for example, frequency modulated and position information is encoded in the modulation. A comprehensive description of the prior art wobble as shown in Figure 1c in a writable CD system comprising disc information encoded in such a manner can be found in U.S. Pat. No. 4,901,300 (PHN 12.398) and U.S. Pat. No. 5,187,699 (PHQ 88.002). The wobble modulation is used to encode physical addresses, for example as shown in FIG. 6, while wobble demodulation is shown in FIG. 7.

According to the invention the record carrier is a multilayer record carrier, each recording layer comprising a pre-formed recording control pattern for indicating the track, for example a pregroove. The pre-formed recording control pattern encodes physical addresses that indicate the physical position of the physical address with respect to a starting point of the track. The physical address has a predefined format which assigns a predefined number of address bits. The physical address is retrieved from the pre-formed recording control pattern for positioning of data blocks with respect to said starting point of the track. At least one address bit of said predefined number of address bits of the physical address is assigned a further function as layer address bit. The layer address bit has (or bits have) a value indicating the recording layer, as discussed in detail with reference to FIG. 5 and 6. It is to be noted that for a dual layer disc a single layer address bit is sufficient. However a larger number of layer address bits may be assigned for accommodating more layers. In this document ‘layer address bit’ also includes the arrangement of a few layer address bits together representing a layer number.

In an embodiment the layer address bit is allocated to the most significant bit of the physical address. In practical discs the physical address may not require the most significant bit(s), or the most significant bit(s) may be omitted from the physical address. It is noted that some of the most significant bits of the physical address may be considered redundant, because the recording device has other means for detecting the global radial position of a head. In an embodiment physical addresses having allocated layer bits are alternated with non-modified physical addresses, e.g. three modified physical addresses followed by one non-modified physical address. Reading a few consecutive addresses now provides sufficient information for detecting the layer number and the full physical address.

In an alternative embodiment the least significant bit of the physical address may be allocated as the layer address bit. As a consequence two consecutive physical addresses will have the same value, which reduces the resolution of the physical address. Hence, when searching for a physical address at least two consecutive physical addresses have to be retrieved to determine the position in the track, e.g. if the two consecutive addresses are equal then the second address originally had a I on the least bit of the significant bit physical address.

FIG. 2 shows a recording device for retrieving layer information from physical address information. The device is provided with means for scanning a track on a record carrier 11 which means include a drive unit 21 for rotating the record carrier 11, a head 22, a servo unit 25 for positioning the head 22 on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. The focusing and tracking actuators are driven by actuator signals from the servo unit 25. For reading the radiation reflected by the information layer is detected by a detector of a usual type, e.g. a four-quadrant diode, in the head 22 for generating detector signals coupled to a front-end unit 31 for generating various scanning signals, including a main scanning signal 33 and error signals 35 for tracking and focusing. The error signals 35 are coupled to the servo unit 25 for controlling said tracking and focusing actuators. The error signals 35 are also coupled to a wobble demodulation unit 32 for retrieving the physical addresses and layer information from the wobble modulation. A detailed embodiment of wobble modulation detection is given in FIG. 7. The main scanning signal 33 is processed by read processing unit 30 of a usual type including a demodulator, deformatter and output unit to retrieve the information.

The device is provided with recording means for recording information on a record carrier of a writable or re-writable type, for example CD-R or CD-RW, or DVD+RW or BD. The recording means cooperate with the head 22 and front-end unit 31 for generating a write beam of radiation, and comprise write processing means for processing the input information to generate a write signal to drive the head 22, which write processing means comprise an input unit 27, a formatter 28 and a modulator 29. For writing information the beam of radiation is controlled to create optically detectable marks constituting data blocks in the recording layer. The marks may be in any optically readable form, e.g. in the form of areas with a reflection coefficient different from their surroundings, obtained when recording in materials such as dye, alloy or phase change material, or in the form of areas with a direction of polarization different from their surroundings, obtained when recording in magneto-optical material.

Writing and reading of information for recording on optical disks and formatting, error correcting and channel coding rules are well-known in the art, e.g. from the CD or DVD system. In an embodiment the input unit 27 comprises compression means for input signals such as analog audio and/or video, or digital uncompressed audio/video. Suitable compression means are described for video in the MPEG standards, MPEG-1 is defined in ISO/IEC 11172 and MPEG-2 is defined in ISO/IEC 13818. The input signal may alternatively be already encoded according to such standards.

The control unit 20 controls the scanning and retrieving of information and may be arranged for receiving commands from a user or from a host computer. The control unit 20 is connected via control lines 26, e.g. a system bus, to the other units in the device. The control unit 20 comprises control circuitry, for example a microprocessor, a program memory and interfaces for performing the procedures and functions as described below. The control unit 20 may also be implemented as a state machine in logic circuits.

The device has a layer unit 34 that is coupled to the wobble demodulation unit for detecting from the layer address bit(s) the actual layer number of the layer that is being scanned. In an embodiment the layer unit is arranged for interrupting the recording of data blocks when an error is detected in the layer number. Hence a deviation of the intended recording layer number and the actual layer number detected is classified as an erroneous situation, which is terminated.

FIG. 3 shows a multilayer optical disc. L0 is a first recording layer 40 and L1 is a second recording layer 41. A first transparent layer 43 covers the first recording layer, a transparent spacer layer 42 separates both recording layers 40,41 and a substrate layer 44 is shown below the second recording layer 41. The first recording layer 40 is located at a position closer to an entrance face 47 of the record carrier than the second recording layer 41. A laser beam is shown in a first state 45 focused on the L0 layer and the laser beam is shown in a second state 46 focused at the L1 layer. Each recording layer has the wobble modulation of the pregroove that encodes physical address information including the layer address bit(s). In a practical embodiment the layer address bit has the value zero in the first recording layer.

Multilayer discs are already available as read-only pre-recorded discs, such as DVD-ROM or DVD-Video. A dual layer DVD+R disc has recently been suggested, which disc should preferably be compatible with the dual layer DVD-ROM standard. The reflection levels of both layers are >18%. The L0 layer has a transmission around 50-70%. A spacer layer separates the layers with a typical thickness between 30 and 60 μm. The L1 layer has a high reflection and needs to be very sensitive. Also rewritable dual-layer discs are proposed. The L0 layer has a transmission around 40-60%. The effective reflection of both layers is typically 7% although lower and higher values are possible (3%-18%). Writable and rewritable optical storage media having 3 or more recording layers are considered also. Due to the required compatibility with existing read-only standardized record carriers, like the DVD-ROM standard, for a DVD-type dual-layer recordable (or rewritable) disc there are two options possible for the layout of the disc. These two options are referred to as ‘parallel track path’ (PTP) and ‘opposite track path’ (OTP), which indicates the direction of the spiral in both layers. In PTP discs there is one information zone per layer (two in total), while in OTP discs there is one information zone extending over the two layers.

FIG. 4 shows schematically an opposite track path record carrier. Horizontally arrow 51 indicates the radial position (increasing outward) and vertically arrow 52 indicates the physical addresses, i.e. sector numbers. Curve 49 indicates the increasing addresses on the L0 layer 40 going outward, while curve 50 indicates the addresses on the L1 layer 41 further increasing going inward. The recording zone have a first data zone 54 on L0 and a second part 57 on L1, interrupted by a middle zone constituted by a first intermediate part 55 at the end of the recording L0 layer 40 and a second intermediate part 56 at the beginning (in track direction) of the L1 recording layer 41. The arrows in the data zones 54,57 indicate the spiral direction. The recording zone is preceded by a lead-in zone 53 at the beginning of the L0 recording layer and concluded by a lead-out zone 58 at the end of the L1 recording layer. It is noted that a multilayer disc having more than two layers may have a third intermediate area at the end of the second recording layer and a fourth intermediate area at the beginning of the third recording layer, and so on. The lead-out zone concludes the last recording layer. According to the invention physical address information on each layer is encoded in the pregroove wobble. The physical address includes one or more layer address bits. In an embodiment the layer address bit has the value one in the second recording layer, and the layer address bit has the value zero in the first recording layer. Such an assignment of values corresponds to values of the most significant bit of logical addresses in the dual layer DVD of the OTP type.

FIG. 5 shows ADIP word data. The Figure lists the Bit 0 to Bit 51 that can be encoded using the ADIP wobble encoding described with FIG. 6. Bit 0 and Bit I have a fixed value. Bit 2 to Bit 23 constitute the 22 bit physical address 59. The physical address 59 is shown in detail, having a layer address bit 60 assigned to Bit2, while the remaining bits 3 to 22 constitute the effective physical address. The format of the ADIP bits further has 8 auxiliary bits (Bit 24 to 31) which must be set to zero in the data zone and 20 bits for error correction (Bit 32 to 51, Parity Nibbles). In DVD the number of bytes is limited to 4.7 GB, and data blocks of 2048 bytes are used. Hence the most significant bit (Bit2) is not required for addressing. Bit2 is allocated as layer address bit and has the value 0 for the L0 layer most close to the laser or 1 for the layer L1 farthest away from the laser. The first ADIP bit (Bit I which is reserved and set to zero) can be used for other purposes.

As a second example a 4-layer disc (all layers are readable from the same side) is discussed. In this case the two most significant bits from the physical address are used (e.g. 00 for layer 1, 01 for layer 1, 10 for layer 3 and 11 for layer 4). In general the number of bits used for the layer identification can be found from the relation:
N_{msb=}²log(NumberofLayers)
(in case of non integer round to next highest integer number)
The total number of layers can be specified in the lead-in zone, and the number of bits allocated for assigning a layer number can be derived, or also explicitly specified.

In an embodiment the number of layer address bits is lower than required by the above formula, but at least one. For example odd and even layers are indicated by a single layer address bit. The layer detection in a device is based on first detecting a deviation of the expected layer address bit, and subsequently other control information is to be retrieved to fully determine the layer number. It is noted that most unexpected layer jumps can still be detected from such a limited number of layer address bits.

FIG. 6 shows ADIP information in wobble modulation. The wobble modulation encodes additional information that is called Address In Pregroove (ADIP) in the DVD+RW system. Each ADIP bit 65 is constituted by ADIP bit sync (one wobble period 64 corresponding to 32 channel bits), followed by a ADIP word sync field (3 wobble periods) and the ADIP Data-bit field of 4 wobble periods, followed finally by 85 monotone (i.e. not modulated) wobble periods. The Figure shows a first wobble 61 which is encoded as an ADIP word sync, in which the word sync field has inverted wobbles and the data-bit field has non modulated wobbles. Second wobble 62 encode a data bit value 0 and third wobble 63 encodes a data bit of value 1. The allocation of the physical address and the layer address bits is discussed above with FIG. 5.

FIG. 7 shows a wobble demodulation unit. The input unit 71 provides a push-pull signal derived from the head scanning the track. A filter 72 filters the signal by high pass and low pass filters for isolating the wobble frequency and generating a wobble signal. A phase locked loop 73 is locked to the wobble frequency, and generates via a 32x multiplier 75 the synchronous write clock for recording marks in units of channel bits. A synchronous wobble unit 74 provides a wobble clock period to multiplier 76 which also receives the wobble signal. The output of the multiplier 76 is integrated in integrate and dump unit 77, of which the output is samples via a sample switch to a sync threshold detector 78 coupled to a ADIP bit synchronizer that detects the ADIP bit syncs. A second multiplier 81 is provided with a 4 wobble period signal having two inverted and two non inverted wobbles and the wobble signal on a second input for synchronous detection over 4 wobble periods. A second integrate and dump unit 82 integrates output signal of the multiplier 82, while a bit value threshold detector 83 for detecting the values of the encoded bits.

Although the invention has been mainly explained by embodiments using optical discs based on change of reflection, the invention is also suitable for other record carriers such as rectangular optical cards, magneto-optical discs or any other type of information storage system that has a pre-applied pattern on a writable record carrier. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Record carrier of a writable type for recording information by writing marks in a track via a beam of radiation entering through an entrance face of the record carrier, the marks being recorded in recording units representing addressable blocks of information, the record carrier comprising
at least a first recording layer (40) and a second recording layer (41), the first recording layer being present at a position closer to the entrance face than the second recording layer,
each recording layer comprising a pre-formed recording control pattern for indicating the track, the pattern comprising physical addresses (59) having a predefined number of address bits that indicate the physical position of the physical address with respect to a starting point of the track, and at least one address bit of said predefined number of address bits of the physical address constituting at least one layer address bit (60) that has a value indicating the recording layer.

2. Record carrier as claimed in claim 1, wherein the at least one layer address bit (60) corresponds to the most significant bit of the physical address.

3. Record carrier as claimed in claim 1, wherein the layer address bit has the value zero in the first recording layer.

4. Record carrier as claimed in claim 1, wherein the pre-formed recording control pattern is constituted by a pregroove (14) indicating the position of the track, the pregroove exhibiting a wobble constituted by displacements of the pregroove in a direction transverse to the longitudinal direction of the track, and the wobble exhibiting a modulation representing the physical addresses including the at least one layer address bit.

5. Record carrier as claimed in claim 4, wherein the pregroove on the first recording layer (40) extends spirally in a first direction and the pregroove on the second recording layer (41) extends spirally in a second direction opposite to the first direction for constituting a multi-part recording area (54,57) interrupted by an intermediate zone that physically is constituted by a first intermediate part (55) located at the end of the first recording layer and a second intermediate part (56) located at the start of the second recording layer, and the layer address bit has the value one in the second recording layer.

6. Device for recording marks in a track on a record carrier (11) via a beam of radiation (24), the record carrier comprising
at least a first recording layer (40) and a second recording layer (41), the first recording layer being present at a position closer to the entrance face than the second recording layer,
each recording layer comprising a pre-formed recording control pattern for indicating the track, the pattern comprising physical addresses having a predefined number of address bits that indicate the physical position of the physical address with respect to a starting point of the track, and at least one address bit of said predefined number of address bits of the physical address constituting at least one layer address bit (60) that has a value indicating the recording layer, and at least one address bit of said predefined number of address bits of the physical address constituting at least one layer address bit that has a value indicating the recording layer, the device comprising
a head (22) for providing the beam,
recording means (27,28,29) for writing marks in the track via the beam, the marks being recorded in recording units representing addressable blocks of information,
a front-end unit (31) for generating a scanning signal (33) for detecting marks in the track, and
demodulation means (32) for retrieving the physical addresses including the at least one layer address bit from the pre-formed recording control pattern, and
a layer unit (34) for detecting a recording layer in dependence of the at least one layer address bit.

7. Device as claimed in claim 6, wherein the recording means (27,28,29) are arranged for recording the units representing addressable blocks of information including a logical address field, the logical address field containing a logical address value based on the physical address but differing from the physical address by excluding the at least one layer address bit.

8. Device as claimed in claim 6, wherein the recording means (27,28,29) are arranged for recording the units representing addressable blocks of information including a logical address field, the logical address field containing a logical address value based on the physical address and the at least one layer address bit, in particular the logical address field containing a copy of the predefined number of address bits including the at least one layer address bit.

9. Device as claimed in claim 6, wherein the layer unit (34) is arranged for interrupting a recording process in dependence on a deviation of an intended recording layer value and a layer value detected from the at least one layer address bit.
